(19) United States
(12) Patent Application Publication
(10) Pub. No.: US 2010/0307068 A1
(43) Pub. Date: Dec. 9, 2010

(54) DISPERSION COMPRISING CERIUM OXIDE AND COLLOIDAL SILICON DIOXIDE

(75) Inventor: Michael Kroell, Linsengericht (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GmbH, Essen (DE)

(21) Appl. No.: 12/745,598

(22) PCT Filed: Dec. 1, 2008
(86) PCT No.: PCT/EP08/66496

§ 371 Date: Jun. 1, 2010

(30) Foreign Application Priority Data
Dec. 22, 2007 (DE) 10 2007 062 572.5

(51) Int. Cl. C09K 3/14

(52) U.S. Cl. 51/308

(57) ABSTRACT

A dispersion comprising particles of cerium oxide and particles of cerium oxide and colloidal silicon dioxide, where —the zeta potential of the silicon dioxide particles is negative and that of the cerium oxide particles is positive or equal to zero, and the zeta potential of the dispersion is negative overall, —the mean diameter of the cerium oxide particles is not more than 200 nm silicon dioxide particles is less than 100 nm, —the proportion, based in each case on the total amount of the dispersion, of cerium oxide particles is from 0.1 to 5% by weight silicon dioxide particles is from 0.01 to 10% by weight and —the pH of the dispersion is from 3.5 to <7.5.

The invention relates to a dispersion comprising cerium oxide and silicon dioxide, and to its production and use.

It is known that cerium oxide dispersions can be used to polish glass surfaces, metal surfaces and dielectric surfaces, both for coarse polishing (high material removal, irregular profile, scratches) and for fine polishing (low material removal, smooth surfaces, few scratches, if any). A disadvantage is often found to be that cerium oxide particles and the surface to be polished bear different electrical charges and attract one another as a result. As a consequence, it is difficult to remove the cerium oxide particles from the polished surface again.

U.S. Pat. No. 7,112,123 discloses a dispersion for polishing glass surfaces, metal surfaces and dielectric surfaces, which comprises, as an abrasive, from 0.1 to 50% by weight of cerium oxide particles and from 0.1 to 10% by weight of clay abrasive particles, 90% of the clay abrasive particles having a particle diameter of from 10 nm to 10 μm and 90% of the cerium oxide particles having a particle diameter of from 100 nm to 10 μm. Cerium oxide particles, clay abrasive particles and glass as the surface to be polished have a negative surface charge. Such a dispersion enables significantly higher material removal than a dispersion based only on cerium oxide particles. However, such a dispersion causes a high defect rate.

U.S. Pat. No. 5,891,205 discloses an alkaline dispersion which comprises silicon dioxide and cerium oxide. The particle size of the cerium oxide particles is less than or equal to the size of the silicon dioxide particles. The cerium oxide particles present in the dispersion stem from a gas phase process, are not aggregated and have a particle size which is less than or equal to 100 nm. According to U.S. Pat. No. 5,891,205, the presence of cerium oxide particles and silicon dioxide particles allows the removal rate to be increased drastically. In order to achieve this, the silicon dioxide/cerium oxide weight ratio should be from 7.5:1 to 1:1. The silicon dioxide preferably has a particle size of less than 50 nm and the cerium oxide one of less than 40 nm. In summary, the proportion a) of silicon dioxide is greater than the proportion of cerium oxide and b) the silicon dioxide particles are larger than the cerium oxide particles.

The dispersion disclosed in U.S. Pat. No. 5,891,205 enables significantly higher removal than a dispersion based only on cerium oxide particles. However, such a dispersion causes a high defect rate.

U.S. Pat. No. 6,491,843 discloses an aqueous dispersion which is said to have a high selectivity with regard to the removal rate of SiO₂ and Si₃N₄. This dispersion comprises abrasive particles and an organic compound which has both a carboxyl group and a second chloride- or amine-containing functional group. Suitable organic compounds mentioned are amino acids. In principle, all abrasive particles are said to be suitable, preference being given especially to aluminum oxide, cerium oxide, copper oxide, iron oxide, nickel oxide, manganese oxide, silicon dioxide, silicon carbide, silicon nitride, tin oxide, titanium dioxide, titanium carbide, tungsten oxide, yttrium oxide, zirconium oxide or mixtures of the aforementioned compounds. In the working examples, however, only cerium oxide is specified as abrasive particles.

What are desired are dispersions which afford a high material removal rate with a low defect rate and high selectivity. After the polishing and cleaning of the wafers, only a small amount of deposits, if any, should be present on the surface.

It has now been found that, surprisingly, the object is achieved by a dispersion which comprises particles of cerium oxide and colloidal silicon dioxide, where
the zeta potential of the silicon dioxide particles is negative and that of the cerium oxide particles is positive or equal to zero, and the zeta potential of the dispersion is negative overall,
the mean diameter of the
   cerium oxide particles is not more than 200 nm
   silicon dioxide particles is less than 100 nm,
the proportion, based in each case on the total amount of the dispersion, of
   cerium oxide particles is from 0.01 to 50% by weight
   silicon dioxide particles is from 0.01 to 10% by weight and
the pH of the dispersion is from 3.5 to <7.5.

The zeta potential is a measure of the surface charge of the particles. The zeta potential is understood to mean the potential at the shear level within the electrochemical double layer of particle/electrolyte in the dispersion. An important parameter in connection with the zeta potential is the isoelectric point (IEP) for a particle. The IEP specifies the pH at which the zeta potential is zero. The greater the zeta potential, the more stable is the dispersion.

The charge density at the surface can be influenced by changing the concentration of the potential-determining ions in the surrounding electrolyte.

Particles of the same material will have the same sign of the surface charges and thus repel one another. When the zeta potential is too small, the repulsive force, however, cannot compensate for the van der Waals attraction of the particles, and there is flocculation and possibly sedimentation of the particles.

The zeta potential can, for example, be determined by measuring the colloidal vibration current (CVI) of the dispersion or by determining the electrophoretic mobility.

Moreover, the zeta potential can be determined by means of the electrokinetic sound amplitude (ESA).

The inventive dispersion preferably has a zeta potential of from −10 to −100 mV and more preferably one of from −25 to −50 mV.

The inventive dispersion also features a pH of 3.5 to <7.5. It allows, for example, the polishing of dielectric surfaces in the alkaline range. Preference may be given to a dispersion which has a pH of 5.5. to 7.4.

The proportion of cerium oxide in the inventive dispersion can be varied over a range from 0.01 to 50% by weight based on the dispersion. High cerium oxide contents are desired when the intention is, for example, to minimize transport costs. In the case of use as a polishing agent, the content of cerium oxide is preferably from 0.1 to 5% by weight and more preferably from 0.2 to 1% by weight, based on the dispersion.

The proportion of colloidal silicon dioxide in the inventive dispersion is from 0.01 to 10% by weight, based on the dispersion. For polishing purposes, a range from 0.05 to 0.5% by weight is preferred.

The cerium oxide/silicon dioxide weight ratio in the inventive dispersion is preferably from 1.1:1 to 100:1. It has been found to be advantageous in polishing processes when the cerium oxide/silicon dioxide weight ratio is from 1.25:1 to 5:1.

Moreover, preference may be given to an inventive dispersion in which, apart from cerium oxide particles and colloidal silicon dioxide particles, no further particles are present.

The mean particle diameter of the cerium oxide particles in the inventive dispersion is not more than 200 nm. Preference is given to a range from 40 to 90 nm. Within this range, the best results arise in polishing processes with regard to material removal, selectivity and defect rate.

The cerium oxide particles may be present as isolated individual particles, or else in the form of aggregated primary particles. The inventive dispersion preferably comprises aggregated cerium oxide particles, or the cerium oxide particles are present predominantly or completely in aggregated form.

Particularly suitable cerium oxide particles have been found to be those which contain carbonate groups on their surface and in layers close to the surface, especially those as disclosed in DE-A-102005038136. These are cerium oxide particles which
have a BET surface area of from 25 to 150 m²/g,
the primary particles have a mean diameter of from to 50 nm,
the layer of the primary particles close to the surface has a depth of approx. 5 nm,
in the layer close to the surface, the carbonate concentration, proceeding from the surface at which the carbonate concentration is at its highest, decreases toward the interior,
the carbon content on the surface which stems from the carbonate groups is from 5 to 50 area percent and, in the layer close to the surface, is from 0 to 30 area percent in a depth of approx. 5 nm
the content of cerium oxide, calculated as CeO₂ and based on the powder, is at least 99.5% by weight and
the content of carbon, comprising organic and inorganic carbon, is from 0.01 to 0.3% by weight, based on the powder.

The carbonate groups can be detected both at the surface and in a depth up to approx. 5 nm of the cerium oxide particles. The carbonate groups are chemically bonded and may, for example, be arranged as in the structures a-c.

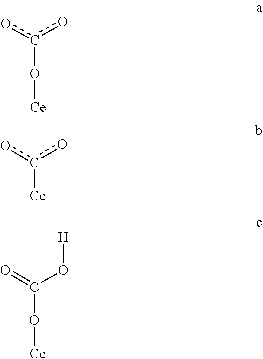

The carbonate groups can be detected, for example, by XPS/ESCA analysis. To detect the carbonate groups in the layer close to the surface, some of the surface can be ablated by means of argon ion bombardment, and the new surface which arises can likewise be analyzed by means of XPS/ESCA (XPS=X-ray Photoelectron Spectroscopy; ESCA=Electron Spectroscopy for Chemical Analysis).

The content of sodium is generally not more than 5 ppm and that of chlorine not more than 20 ppm. The elements mentioned are generally tolerable only in small amounts in chemical-mechanical polishing.

The cerium oxide particles used preferably have a BET surface area of from 30 to 100 m²/g and more preferably of 40 to 80 m²/g.

The colloidal silicon dioxide particles of the inventive dispersion have a mean particle diameter of less than 100 nm. Preference is given to the range from 3 to 50 nm and particular preference to the range from 10 to 35 nm.

Colloidal silicon dioxide particles are understood to mean those which are present in the form of individual particles which are uncrosslinked with each other, are spherical or very substantially spherical and have hydroxyl groups on the surface.

It has been found to be particularly advantageous when the cerium oxide particles, on their surface and in layers close to the surface, comprise carbonate groups and the pH of the dispersion is from 3.5 to <7.5.

The inventive dispersion may further comprise one or more aminocarboxylic acids with a proportion, in total, of from 0.01 to 5% by weight, based on the dispersion. These are preferably selected from the group consisting of alanine, 4-aminobutanecarboxylic acid, 6-aminohexanecarboxylic acid, 12-aminolauric acid, arginine, aspartic acid, glutamic acid, glycine, glycylglycine, lysine and proline. Particular preference is given to glutamic acid and proline.

The proportion of amino acid or salt thereof in the dispersion is preferably from 0.1 to 0.6% by weight.

The liquid phase of the inventive dispersion comprises water, organic solvents and mixtures of water with organic solvents. In general, the main constituent, with a content of >90% by weight of the liquid phase, is water.

In addition, the inventive dispersion may also comprise acids, bases, salts. The pH can be adjusted by means of acids or bases. The acids used may be inorganic acids, organic acids or mixtures of the aforementioned. The inorganic acids used may in particular be phosphoric acid, phosphorous acid, nitric acid, sulfuric acid, mixtures thereof, and their acidic salts. The organic acids used are preferably carboxylic acids of the general formula CₙH₂ₙ₊₁CO₂H, where n=0-6 or n=8, 10, 12, 14, 16, or dicarboxylic acids of the general formula HO₂C(CH₂)ₙCO₂H, where n=0-4, or hydroxycarboxylic acids of the general formula R₁R₂C(OH)CO₂H, where R₁═H, R₂═CH₃, CH₂CO₂H, CH(OH)CO₂H, or phthalic acid or salicylic acid, or acidic salts of the aforementioned acids or mixtures of the aforementioned acids and their salts. The pH can be increased by adding ammonia, alkali metal hydroxides or amines.

In particular applications, it may be advantageous when the inventive dispersion contains 0.3-20% by weight of an oxidizing agent. For this purpose, it is possible to use hydrogen peroxide, a hydrogen peroxide adduct, for example the urea adduct, an organic peracid, an inorganic peracid, an imino peracid, a persulfate, perborate, percarbonate, oxidizing metal salts and/or mixtures of the above.

Owing to the reduced stability of some oxidizing agents toward other constituents of the inventive dispersion, it may be advisable not to add them until immediately before the utilization of the dispersion.

The inventive dispersion may further comprise oxidation activators. Suitable oxidation activators may be the metal salts of Ag, Co, Cr, Cu, Fe, Mo, Mn, Ni, Os, Pd, Ru, Sn, Ti, V and mixtures thereof. Also suitable are carboxylic acids, nitriles, ureas, amides and esters. Iron(II) nitrate may be particularly preferred. The concentration of the oxidation catalyst may, depending on the oxidizing agent and the polishing task, be varied within a range between 0.001 and 2% by weight. More preferably, the range may be between 0.01 and 0.05% by weight.

The corrosion inhibitors, which are generally present in the inventive dispersion with a content of from 0.001 to 2% by weight, may be nitrogen-containing heterocycles such as benzotriazole, substituted benzimidazoles, substituted pyrazines, substituted pyrazoles and mixtures thereof.

The invention further provides a process for producing the inventive dispersion in which
cerium oxide particles in powder form are introduced and subsequently dispersed into a predispersion comprising colloidal silicon dioxide particles or
a predispersion comprising cerium oxide particles and a predispersion comprising colloidal silicon dioxide particles are combined and subsequently dispersed, and then
optionally one or more amino acids are added in solid, liquid or dissolved form and then
optionally oxidizing agent, oxidation catalyst and/or corrosion inhibitor.

Suitable dispersing units are especially those which bring about an energy input of at least 200 kJ/m³. These include systems operating by the rotor-stator principle, for example Ultra-Turrax machines, or stirred ball mills. Higher energy inputs are possible with a planetary kneader/mixer. However, the efficacy of this system is combined with a sufficiently high viscosity of the processed mixture in order to introduce the required high shear energies to divide the particles.

High-pressure homogenizers are used to decompress two predispersed suspension streams under high pressure through a nozzle. The two dispersion jets meet one another exactly and the particles grind one another. In another embodiment, the predispersion is likewise placed under high pressure, but the particles collide against armored wall regions. The operation can be repeated as often as desired in order to obtain smaller particle sizes.

Moreover, the energy input can also be effected by means of ultrasound.

The dispersion and grinding apparatus can also be used in combination. Oxidizing agents and additives can be supplied at different times to the dispersion. It may also be advantageous, for example, not to incorporate oxidizing agents and oxidation activators until the end of the dispersion, if appropriate at lower energy input.

The zeta potential of the colloidal silicon dioxide particles used is preferably from −10 to −100 mV, at a pH of from 3.5 to 7.4.

The zeta potential of the cerium oxide particles used is preferably from 0 to 60 mV, at a pH of from 3.5 to 7.4.

The invention further provides for the use of the inventive dispersion for polishing dielectric surfaces.

In the sector of STI-CMP (STI=shallow trench isolation, CMP=chemical mechanical polishing), the inventive dispersion leads to a high SiO₂:Si₃N₄ selecitivity. This means that the SiO₂ removal achieved by the dispersion is significantly greater than the removal of Si₃N₄ achieved by the same slurry. The inventive dispersion contributes to this by virtue of its pH being 3.5 to <7.5. At these pH values, the hydrolysis of Si₃N₄ to SiO₂ is minimal or not present. The SiO₂ removal which is low at these pH values can be increased again by organic additives such as amino acids.

### EXAMPLES

### Analysis

The specific surface area is determined to DIN 66131.

The surface properties are determined by large-area (1 cm²) XPS/ESCA analysis (XPS=X-ray Photoelectronic Spectroscopy; ESCA=Electron Spectroscopy for Chemical Analysis). The evaluation is based on the general recommendations according to DIN Technical Report No. 39, DMA(A)97 of the National Physical Laboratory, Teddington, U.K., and the findings to date regarding the development-accompanying standardization of the “Surface and Micro Range Analyses” working committee NMP816 (DIN). In addition, the comparative spectra available in each case from the technical literature are taken into account. The values are calculated by background subtraction taking account of the relative sensitivity factors of the electron level reported in each case. The data are in area percent. The precision is estimated at +/−5% relative.

The zeta potential is determined in the pH range of 3-12 by means of the electrokinetic sound amplitude (ESA). To this end, a suspension comprising 1% cerium oxide is prepared. The dispersion is effected with an ultrasound probe (400 W). The suspension is stirred with a magnetic stirrer and pumped by means of a peristaltic pump through the PPL-80 sensor of the Matec ESA-8000 instrument. From the starting pH, the potentiometric titration with 5M NaOH commences up to pH 12. The back-titration to pH 4 is undertaken with 5M HNO₃. The evaluation is effected by means of the instrument software version pcava 5.94.

$$ζ = \frac{ESA \cdot η}{φ \cdot Δρ \cdot c \cdot \vert G ( α ) \vert \cdot ɛ \cdot {ɛ}_{r}}$$

where ζ is zeta potential, φ is volume fraction, Δρ is density difference between particles and liquid, c is speed of sound in the suspension, η is viscosity of the liquid, ∈ is dielectric constant of the suspension, |G(α)| is correction for inertia.

The mean aggregate diameters are determined with a Horiba LB-500 particle size analyzer.

### Feedstocks

The feedstocks used to prepare dispersions are a pyrogenic cerium oxide as described in DE-A-102005038136, example 2. The colloidal silicon dioxides used are two Levasil® grades from H.C. Starck. Important physicochemical parameters of these substances are reported in table 1.

TABLE 1
Feed stocks

| | | | Zeta | Particle |
|---|---|---|---|---|
| | | BET | potential | diameter^{a)} |
| | | m²/g | mV | nm |
| 1 | Cerium oxide | 60 | 35 (7.4) | 65 |
| 2a | Levasil ® 300 | 300 | −20 (7.4) | 13 |
| 2b | Levasil ® 500 | 500 | −22 (7.4) | 23 |

^{a)}determined Horiba LB-500 particle size analyzer

### Wafer/Pad:

Silicon dioxide (200 mm, layer thickness 1000 nm, thermal oxide, from SiMat) and silicon nitride (200 mm, layer thickness 160 nm, LPCVD, from SiMat). Rodel IC 1000-A3 pad.

### Preparation of the Dispersions

D1: The dispersion is obtained by adding cerium oxide powder to water, and dispersing it by ultrasound treatment with an ultrasound finger (from Bandelin UW2200/DH13G, level 8, 100%; 5 minutes). Subsequently, the pH is adjusted to 7.0 with aqueous ammonia.

D2a-D3a: The dispersions are obtained by mixing a predispersion consisting of cerium oxide and water and a predispersion consisting of colloidal silicon dioxide and water, dispersing it by ultrasound treatment with an ultrasound finger (from Bandelin UW2200/DH13G, level 8, 100%; 5 minutes) subsequently adding glutamic acid in the case of dispersions D2-1b, D2-2b and D3b, and adjusting the pH to 7.0. Table 2 shows important parameters of the resulting dispersions. Table 3 shows the polishing ablations and selectivities after makeup of the dispersion.

As compared with dispersion D1, which contains only cerium oxide, the inventive dispersions have a comparable removal of silicon dioxide and silicon nitride, but the number of scratches on the surface is significantly smaller.

### Assessment of Polishing Residues on Wafers and Pads

The polishing residues are assessed visually (also by light microscope in the range of up to 64-fold magnification).

To this end, the particle sizes of dispersions D1 (comparative) and D2-1a, D2-2a, D3 (inventive) are analyzed directly after polishing:
D1 is unstable and sediments as early as after a few minutes. The particle size measured is significantly above one micrometer.
the inventive dispersions, in contrast, are still stable even after polishing. This means that there is no formation of large agglomerates in the case of these dispersions. The polished wafers also exhibit a considerably lower level of residues.

The addition of negatively charged colloidal silicon dioxide particles, especially in the presence of an amino acid, influences the polishing quality of a cerium oxide-comprising dispersion in a positive manner by reducing the proportion of polishing residues.

One possible mechanism comprises the outward screening of positively charged cerium oxide particles by negatively charged colloidal silicon dioxide particles, ensuring effective reversal of the charge of the cerium oxide particles. As a result of this reversal of charge, the inventive dispersion offers, inter alia, the possibility of polishing at pH values close to the IEP of the pure cerium oxide. Since the interactions are electrostatic interactions, the colloidal silicon dioxide particles can be sheared off during the polishing operation, so that the polishing action of the cerium oxide is maintained. As a result of all particles always being outwardly negatively charged during the entire polishing operation, agglomerate formation is significantly reduced. Long-term analyses show that the stability and polishing properties are maintained even over prolonged periods.

TABLE 2
Dispersions

| | | Dispersion | | | | | |
|---|---|---|---|---|---|---|---|
| | | D1 | D2a | D3a | D2-1b | D2-2b | D3 |
| Cerium oxide | % by wt. | 0.5 | 0.5 | 0.5 | 0.5 | 0.5 | 0.5 |
| Colloidal SiO₂ | # | — | 2a | 2b | 2a | 2a | 2b |
| | % by wt. | 0 | 0.18 | 0.125 | 0.18 | 0.18 | 0.125 |
| amino acid | | — | — | — | Glu** | Glu | Glu |
| | % by wt. | 0 | 0 | 0 | 0.1 | 0.5 | 0.5 |
| pH | | 7.0 | 7.0 | 7.0 | 7.0 | 7.0 | 7.0 |
| Zeta potential | mV | 42 | −15 | −16 | −16 | −17 | −14 |
| Particle diameter | nm | 60 | 100 | 83 | 78 | 144 | 95 |

* weighted to particle number;
**Glu = glutamic acid

TABLE 3
Polishing results

| | | Dispersion | | | | | |
|---|---|---|---|---|---|---|---|
| | | D1 | D2a | D3a | D2-1b | D2-2b | D3 |
| RR SiO₂ | nm/min | 275 | 190 | 225 | 265 | 355 | 245 |
| RR Si₃N₄ | nm/min | 72 | 76 | 88 | 37 | 85 | 87 |

1. A dispersion comprising particles of cerium oxide and colloidal silicon dioxide, where
a zeta potential of the silicon dioxide particles is negative and a zeta potential of the cerium oxide particles is positive or equal to zero, and a zeta potential of the dispersion is negative overall,
a mean diameter of the
cerium oxide particles is not more than 200 nm and
the mean diameter of silicon dioxide particles is less than 100 nm, a content based on the total amount of the dispersion, of
cerium oxide particles is from 0.1 to 5% by weight and
a content of silicon dioxide particles is from 0.01 to 10% by weight and
a pH of the dispersion is 3.5 or higher and less than 7.5.

2. The dispersion as claimed in claim 1, wherein the zeta potential of the dispersion is from −10 to −100 mV.

3. The dispersion as claimed in claim 1, wherein the pH is from 5.5 to 7.4.

4. The dispersion as claimed in claim 1, wherein the content of cerium oxide is from 0.1 to 5% by weight, based on the dispersion.

5. The dispersion as claimed in claim 1, wherein the content of colloidal silicon dioxide is from 0.01 to 10% by weight, based on the dispersion.

6. The dispersion as claimed in claim 1, wherein the cerium oxide/silicon dioxide weight ratio is from 1.1:1 to 100:1.

7. The dispersion as claimed in claim 1, wherein cerium oxide particles and silicon dioxide particles are the only particles in the dispersion.

8. The dispersion as claimed in claim 1, wherein the mean particle diameter of the cerium oxide particles is from 40 to 90 nm.

9. The dispersion as claimed in claim 1, wherein the cerium oxide particles are present in the form of aggregated primary particles.

10. The dispersion as claimed in claim 1, wherein the cerium oxide particles comprise carbonate groups on a surface of the cerium oxide particles and in layers close to the surface.

11. The dispersion as claimed in claim 1, wherein the colloidal silicon dioxide particles have a mean diameter in the range from 3 to 50 nm.

12. The dispersion as claimed in claim 1, further comprising from 0.01 to 5% by weight of at least one of one or more aminocarboxylic acids and salts thereof.

13. The dispersion as claimed in claim 12, wherein the aminocarboxylic acid is selected from the group consisting of alanine, 4-aminobutanecarboxylic acid, 6-aminohexanecarboxylic acid, 12-aminolauric acid, arginine, aspartic acid, glutamic acid, glycine, glycylglycine, lysine and proline.

14. The dispersion as claimed in claim 12, wherein the amino acid or salt thereof is present in the dispersion with a proportion of from 0.1 to 0.6% by weight.

15. The dispersion as claimed in claim 1, wherein water is a main constituent of a liquid phase of the dispersion.

16. The dispersion as claimed in claim 1, comprising at least one of acids, bases, salts, oxidizing agents, oxidation catalysts and corrosion inhibitors.

17. A process for producing the dispersion as claimed in claim 1, comprising
introducing and subsequently dispersing cerium oxide particles in powder form into a predispersion comprising colloidal silicon dioxide particles or
combining and subsequently dispersing a predispersion comprising cerium oxide particles and a predispersion comprising colloidal silicon dioxide particles, and then
optionally adding one or more amino acids in solid, liquid or dissolved form and then
optionally oxidizing at least one of an agent, an oxidation catalyst and a corrosion inhibitor.

18. The process as claimed in claim 17, wherein a zeta potential of the colloidal silicon dioxide particles is from −10 to −100 mV at a pH of 3.5 or higher and less than 7.5.

19. The process as claimed in claim 17, wherein a zeta potential of the cerium oxide particles is from 0 to 60 mV at a pH of 3.5 or higher and less than 7.5.

20. A polarizing dielectric surface, comprising the dispersion as claimed in claim 1.
